(19) United States
(12) Patent Application Publication
(10) Pub. No.: US 2015/0015001 A1
(43) Pub. Date: Jan. 15, 2015

(54) Electric Household Appliance Door Locking Device

(71) Applicant: Electrolux Home Products Corporation N.V., Brussels (BE)

(72) Inventors: Edi FABBRO, Betiolo (UD) (IT); Giancarlo ARRIGONI, Udine (IT); Marco BIASIOTTO, Torino (IT); Tommaso LUCHETTI, Torino (IT)

(73) Assignee: ELECTROLUX HOME PRODUCTS CORPORATION N.V., Brussels (BE)

(21) Appl. No.: 14/294,607

(22) Filed: Jun. 3, 2014

Related U.S. Application Data
(63) Continuation of application No. 14/114,361, now abandoned.

(30) Foreign Application Priority Data
Apr. 28, 2011 (EP) 11164054.6

(51) Int. Cl. D06F 39/14; E05B 47/00

(52) U.S. Cl. CPC D06F 39/14; E05B 47/00
USPC 292/198

(57) ABSTRACT

An electric household appliance having a casing (2); a compartment (3) housed inside the casing (2) and facing an opening (4); a door (5) fitted to the casing (2) and movable between an open position and a closed position; and a locking device (6); the locking device (6) having a box body (7) fixed to the casing (2), alongside the door (5); latch means (8, 13) fitted to the box body (7) to move between a lock position locking the door (5), and a release position releasing the door (5); and an actuating device (11) for selectively moving the latch means (8, 13) between the lock position and the release position, and which has at least an electrically conducting resistance wire (16) made of a shape-memory alloy and designed to vary in length alongside a variation in temperature, and electric power devices (18) for powering the resistance wire (16) and producing a controlled Joule-effect variation in temperature.

### TECHNICAL FIELD OF THE INVENTION

The present invention relates to an electric household appliance door locking device.

More specifically, the present invention relates to a device designed to lock a door or drawer in a closed position closing an opening in the casing of an electric household appliance, such as a washing machine, drier, combination washing machine-drier, dishwashing machine, or oven, to which the following description refers purely by way of example.

As is known, electric household appliances of the above type, e.g. washing machines, comprise a casing; a laundry compartment, such as a drum, mounted inside the casing in a position facing a laundry loading/unloading opening in the casing; and a door hinged to the casing to rotate between an open position and a closed position opening and closing the opening respectively.

Appliances of the above type, e.g. washing machines, also comprise a door locking device designed to lock the door in the closed position closing the opening when the machine is running, or to release the door to allow the user to open it when the machine is in a given rest/off state.

The lock/release devices currently used on electric household appliances normally comprise a lock mechanism, which, when the door is in the closed position, secures the door, on command, to the machine casing; an electric actuating device with a movable pin, which, depending on its position, allows or prevents the lock mechanism from securing the door to the machine casing; and an electronic control unit designed to control the electric actuating device and move the pin according to an electric signal. More specifically, the electric actuating device pin is movable axially between an extracted position forcing the lock mechanism to secure the door to the casing, and a withdrawn position preventing the lock mechanism from securing the door to the casing.

The electric actuating device normally comprises a box body fixed to the appliance casing, alongside the opening, and housing the pin; a solenoid, i.e. an electric coil connected to electric control means by a positive temperature coefficient (PTC) protection device; and a sliding rod, which is fitted inside the solenoid, is connected at its free end to the pin by links and/or by gears with motion-transmission cams, and is moved in and out of the solenoid, between a withdrawn position and an extracted position, by the magnetic field generated by the solenoid, to control the movement of the pin.

The electric actuating device also comprises a safety device designed to automatically cut off electric power to certain electronic/electric devices, normally the electric motor rotating the laundry drum, when the locking device releases the door.

Some safety devices comprise a bimetallic spring; and a positive temperature coefficient (PCT) resistance pad positioned facing the bimetallic spring inside the box body, and which, when traversed by controlled current, lengthens/shortens the bimetallic spring to close or open an electric safety switch series-connected to the electric motor power line. The bimetallic spring is normally designed to cooperate mechanically with the links or gears of the electric actuating device, to prevent the door from opening when the safety switch is closed.

A major drawback of door locking devices of the above type is the high electric consumption of the positive temperature coefficient parts, which, despite the reduction in their resistance when heated, still remain powered throughout operation of the appliance, thus resulting in a far from negligible increase in the total electric consumption of the locking device.

Besides being fairly complicated and therefore expensive to produce, locking devices of the above type also have the drawback of being fairly slow to release, by depending on the time taken by the safety device PTC pad to cool.

### OBJECT AND SUMMARY OF THE INVENTION

Extensive research has been carried out by the Applicant to devise a door locking device which:
is electrically and mechanically simpler, and so cheaper and easier to produce; and
has no electronic, positive temperature coefficient components, thus reducing operating power consumption as compared with the door lock/release devices described.

It is therefore an object of the present invention to provide a solution designed to achieve the above goals.

According to the present invention, there is provided an electric household appliance comprising a casing; a compartment housed inside the casing and facing an opening formed in the casing; a door fitted to the casing and movable between an open position and a closed position opening and closing the opening respectively; and a locking device for locking the door in the closed position to the casing, and in turn comprising a box body fixed to the casing, alongside the door; latch means fitted to the box body to move between at least a door lock position and a door release position; and actuating means for selectively moving said latch means between said lock position and said release position; the actuating means comprising an electrically conducting resistance wire made of a shape-memory alloy and designed to vary in length alongside a variation in temperature; and electric power means for powering said wire and producing a controlled Joule-effect variation in temperature.

The present invention preferably also relates to a locking device for locking a door in a closed position closing an opening formed in a casing to allow access to a compartment inside the casing, the locking device comprising a box body fixed to the casing, alongside the door; latch means fitted to the box body to move between at least a door lock position and a door release position; and actuating means for selectively moving said latch means between said lock position and said release position; the actuating means comprising an electrically conducting resistance wire made of a shape-memory alloy and designed to vary in length alongside a variation in temperature; and electric power means for powering said wire and producing a controlled Joule-effect variation in temperature.

The present invention preferably also relates to a locking device for locking in a closed position a drawer mounted to slide inside a compartment in a casing, the locking device comprising a box body fixed to the casing, alongside the drawer; latch means fitted to the box body to move between at least a drawer lock position and a drawer release position; and actuating means for selectively moving said latch means between said lock position and said release position; the actuating means comprising an electrically conducting resistance wire made of a shape-memory alloy and designed to vary in length alongside a variation in temperature; and electric power means for powering said wire and producing a controlled Joule-effect variation in temperature.

### BRIEF DESCRIPTION OF THE DRAWINGS

FIG. 1 shows a schematic front view of an electric household appliance featuring a locking device in accordance with the teachings of the present invention;

FIG. 2 shows a view in perspective, with parts removed for clarity, of the FIG. 1 locking device;

FIGS. 3 to 6 show schematics of the locking device in respective operating states;

FIG. 7 shows a release member for manually releasing the FIG. 1 locking device;

FIG. 8 shows a variation of the FIG. 1 locking device.

### DETAILED DESCRIPTION OF PREFERRED EMBODIMENTS OF THE INVENTION

The following is a detailed description of the invention, with reference to the accompanying drawings, to enable its production and use by a person skilled in the art. As will be clear to anyone skilled in the art, changes may be made to the embodiments described, and the general principles described may also be applied to other embodiments and applications without, however, departing from the protective scope of the invention as defined in the accompanying Claims. In other words, the present invention is not to be inferred as limited to the embodiments described and illustrated, but shall be accorded the widest protective scope consistent with the principles and characteristics described and claimed herein.

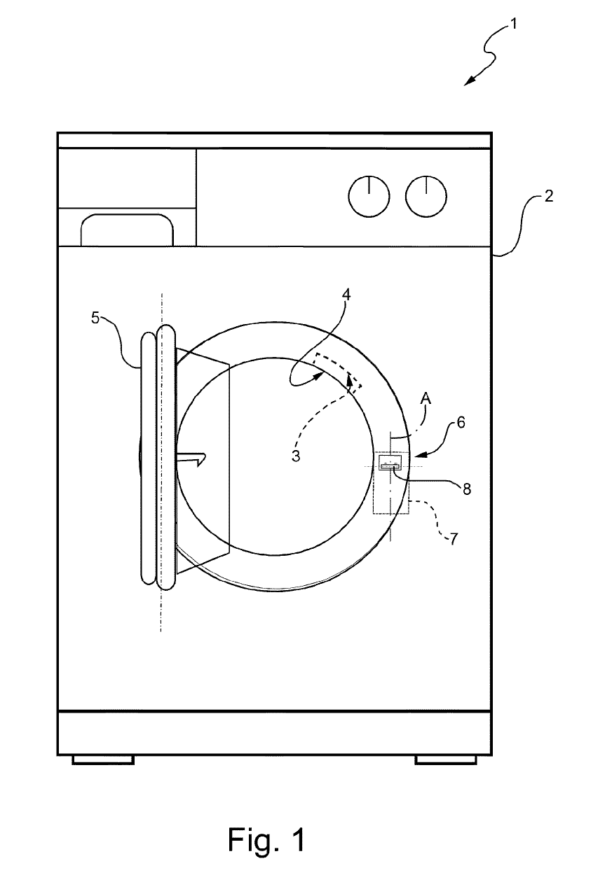

Number 1 in FIG. 1 indicates as a whole an electric household appliance preferably, though not necessarily, corresponding to a washing machine, which comprises a casing 2; an inner compartment 3 corresponding to a laundry drum mounted inside casing 2 and facing an opening 4 in casing 2; and a door 5 hinged to casing 2 to rotate, about a preferably, though not necessarily, vertical axis, between an open position and a closed position opening and closing opening 4 respectively.

In connection with the above, it should be stressed that, though the following description refers specifically to an electric household appliance corresponding to a washing machine, the present invention also applies to other types of electric household appliances, such as driers, combination washing machine-driers, dishwashers, or ovens; in which latter case, inner compartment 3 corresponds to a baking compartment formed in the oven casing, and the door corresponds to a door hinged to the casing to close the access opening to the baking compartment.

Appliance 1 also comprises a locking device 6 for locking door 5 in the closed position closing opening 4, when appliance 1 is in a predetermined operating state, or for releasing door 5 to allow it to move, or be moved, into the open position (FIG. 1) when appliance 1 is in a predetermined rest state.

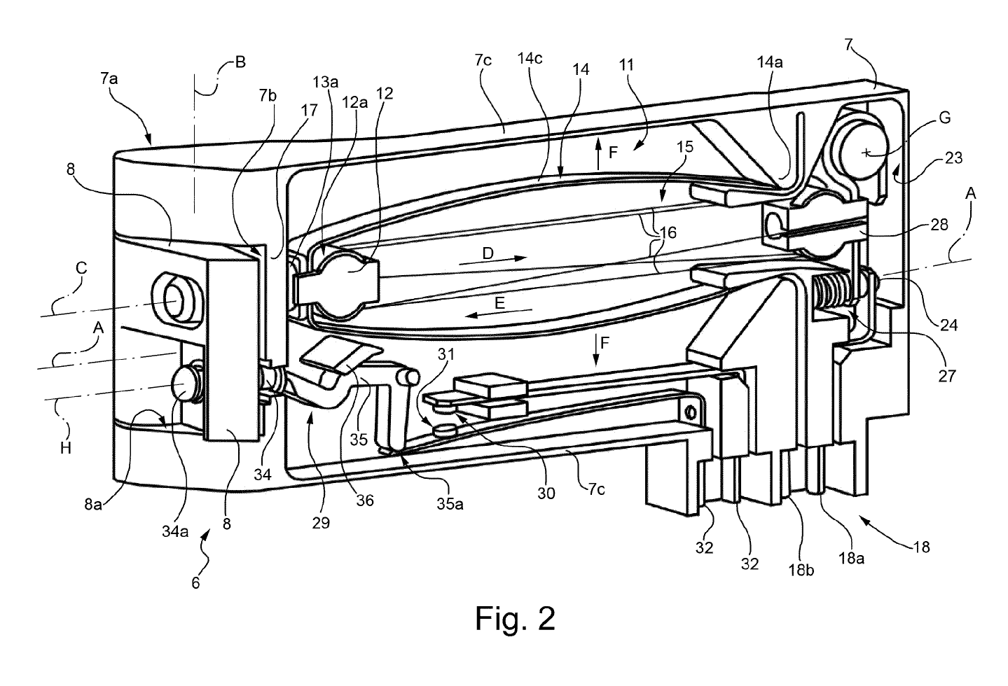

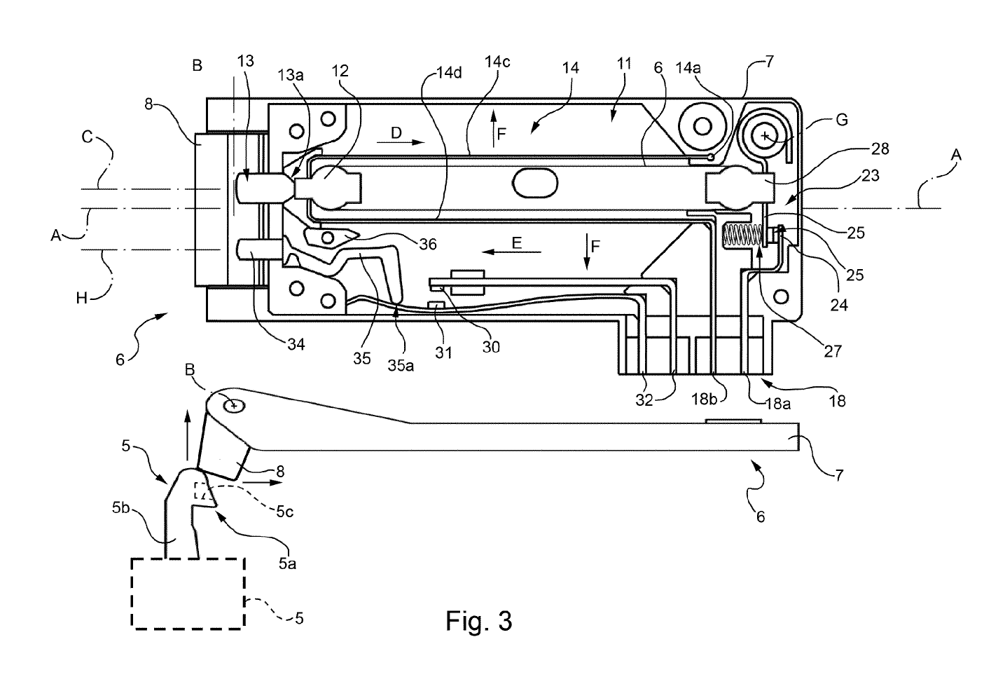

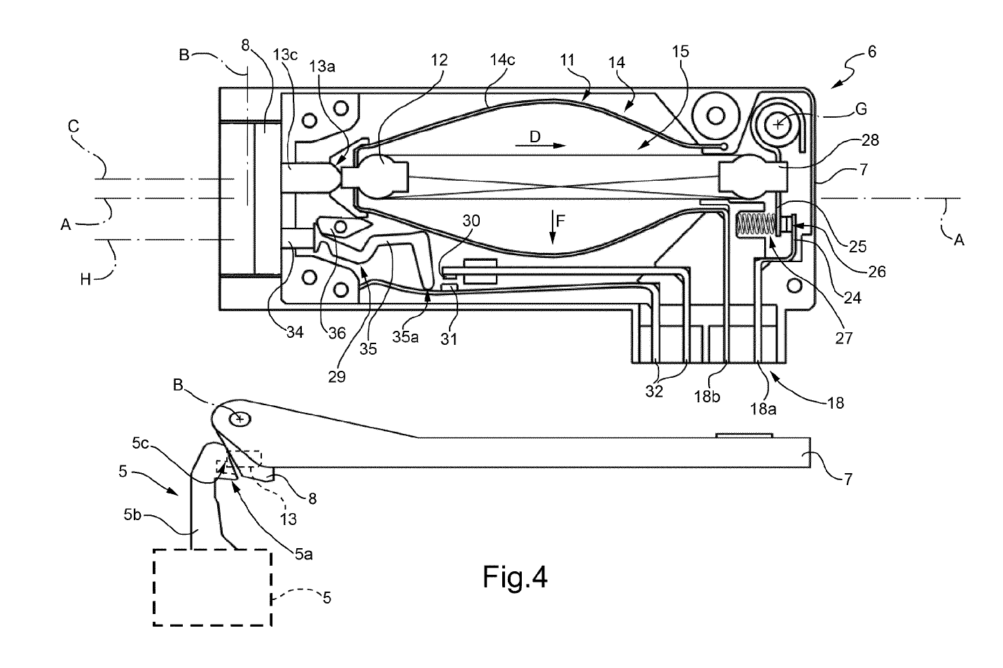

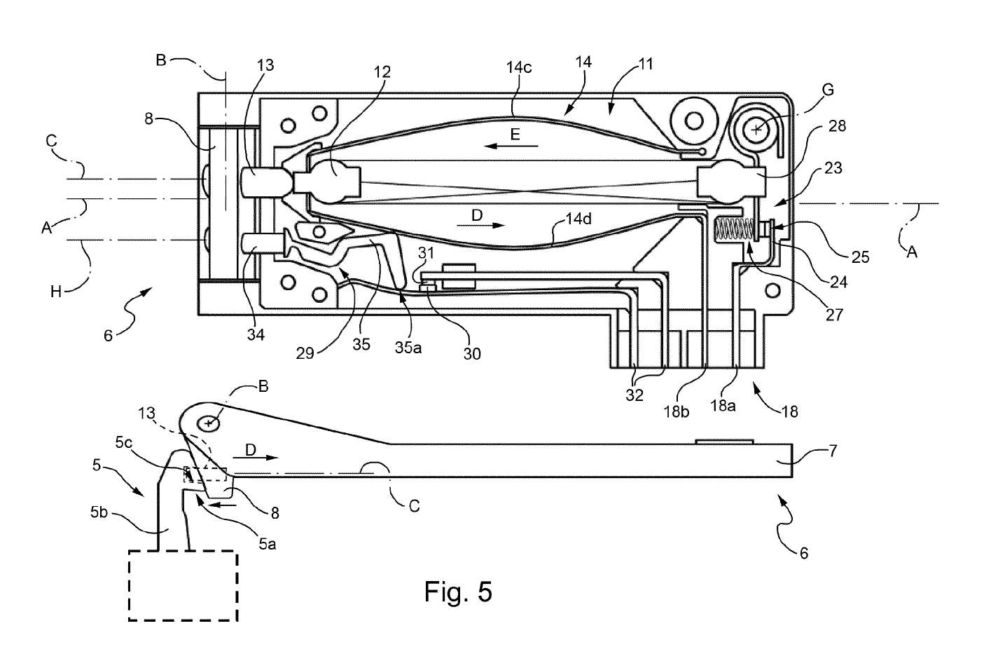

With reference to FIGS. 1 and 2, locking device 6 comprises a preferably, though not necessarily, parallelepiped-shaped box body 7 having a longitudinal axis A and fixed to casing 2, alongside opening 4; and a latch 8 hinged to a first end 7a of box body 7 to rotate, about an axis of rotation B perpendicular to axis A, between a lock position (FIG. 5), in which latch 8 engages a catch 5a, projecting from the end of a catch arm 5b on door 5, to lock door in the closed position; a release position (FIG. 4), in which latch 8 is released from catch 5a on door 5, to permit withdrawal of catch 5a from latch 8 and disconnect door from casing 2; and a rest position (FIG. 3), in which latch 8 is fully released from catch 5a on the catch arm on door 5.

Locking device 6 also comprises an actuator 11 housed inside box body 7 and designed to move latch 8 selectively into the lock position, in which latch 8 is locked to catch 5a on door 5; into the release position, in which latch 8 is released from catch 5a to open door 5; or into the rest position, in which catch 5a is fully detached from latch 8.

In the FIG. 2-6 embodiment, actuator 11 comprises a movable end member or carriage 12, which is mounted to slide on the major inner face of box body 7 along an axis C parallel to axis A, and is connected mechanically to latch 8 so that the axial movement of carriage 12 rotates latch 8 selectively about axis B into the rest position, lock position, or release position.

More specifically, carriage 12 is movable between a first position (FIG. 3) at a minimum distance from end 7a to hold latch 8 in the rest position; a second position (FIG. 4) at a maximum distance from end 7a to hold latch 8 in the release position; and a third position (FIG. 5) at an intermediate distance, between the minimum and maximum distances, from end 7a, to hold latch 8 in the lock position.

More specifically, carriage 12 moves in a reverse direction D into the second position, or in a forward direction E, opposite reverse direction D, into the first position.

In the FIG. 2-6 embodiment, actuator 11 also comprises elastic thrust means 14 designed to exert a predetermined elastic force on carriage 12 in direction E, so as to elastically oppose the movement of carriage in reverse direction D and push it into the first position.

Actuator 11 also comprises at least one shape-memory thrust-bearing device 15 in turn comprising at least one electrically conducting resistance wire 16 made of shape-memory alloy (SMA), and which extends parallel to axis A, has at least a first end or first portion connected to box body 7, and at least a second end or second portion connected to carriage 12, and is designed to vary in length alongside a variation in temperature, to move carriage 12 in reverse direction D; and electric wire powering means 18 for producing a controlled Joule-effect variation in the temperature and, hence, length of wire 16.

In a preferred embodiment shown in FIG. 2, carriage 12 is mounted to slide inside a seat (not shown) formed in the major inner face of box body 7, and has a preferably, though not necessarily, cylindrical outer surface portion 12a, about which portions of wire 16 are wound.

Carriage 12 is separated from latch 8 by a wall or partition 17 perpendicular to axis A, and an outer face of which, on the opposite side to carriage 12, forms an inner supporting wall of a seat 7b housing latch 8. More specifically, in the release position, the outer supporting surface, opposite the inner lock surface, of latch 8 is positioned resting on the outer face of partition 17, i.e. on the supporting wall of seat 7b housing latch 8.

In the FIG. 2-6 example, latch 8 is held in the rest position inside seat 7b by known elastic members (not shown) designed to elastically oppose rotation of latch 8 towards the supporting wall, and is connected to carriage 12 by a traction pin 13 designed to rotate latch 8 towards the supporting wall of partition 17 when carriage 12 moves in reverse direction D, or to allow the elastic members to rotate latch 8 away from the supporting wall of partition 17 when carriage 12 moves in forward direction E.

In the FIG. 3-6 example, traction pin 13 preferably extends coaxially with axis C, and comprises a rear portion 13a fixed firmly to surface portion 12a of carriage 12 wound with wire 16; a front portion 13b projecting from the lock surface of latch 8 and designed to engage a slot 5c formed in an outer surface portion of catch 5a on catch arm 5b on door 5; and an intermediate portion 13c fitted and slidable freely inside a through opening or hole in partition 17, and a through opening or hole 20 in latch 8.

In a preferred embodiment shown in FIGS. 3-6, intermediate portion 13c of traction pin 13 is designed to allow latch 8 to move freely with respect to traction pin 13 and rotate between the lock position and rest position when carriage 12 is in the first position, and to hold latch 8 against partition 17 when carriage 12 is in the second position.

Front portion 13b of traction pin 13 is designed to engage slot 5c in catch 5a on door 5 when latch 8 is in the lock position, so as to hold the lock surface of latch 8 resting on the lock surface of catch 5a and connect catch 5a to latch 8, and is designed to secure and rotate latch 8 about axis B towards partition 17 when carriage 12 moves in reverse direction D.

In a preferred embodiment, elastic thrust means 14 comprise a leaf spring, i.e. a U-shaped strap of elastic, electrically conducting material, which has two ends 14a fixed rigidly to respective portions of the lateral walls 7c of box body 7 extending parallel to and on opposite sides of axis A; and a central segment 14b, preferably corresponding to the bend in the spring, fitted firmly to carriage 12 to exert elastic thrust on traction pin 13 in the forward direction E.

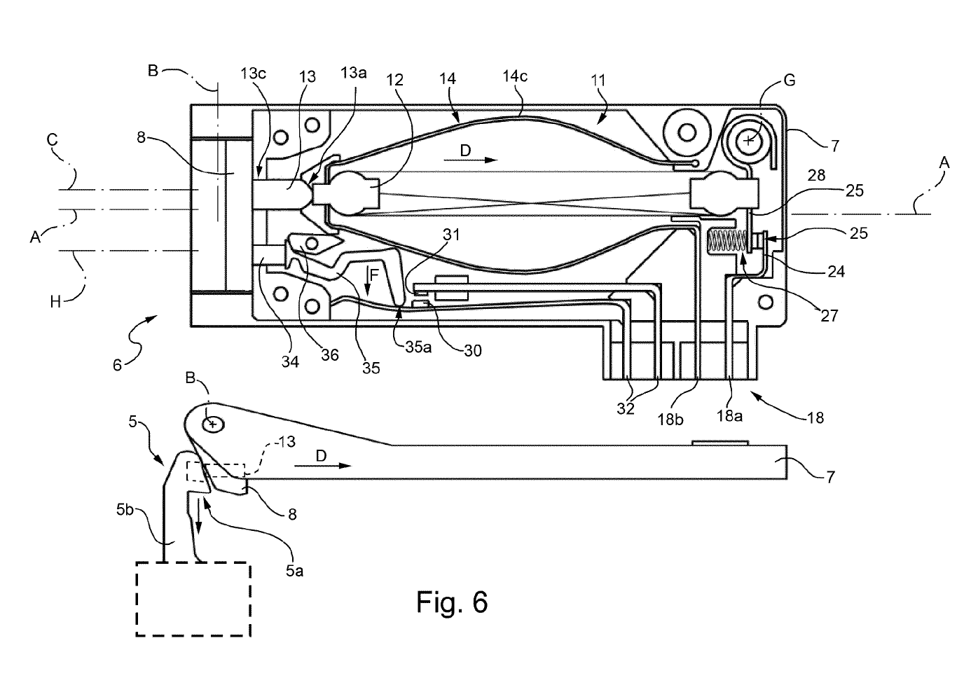

In the FIG. 2-6 example, central segment 14b of leaf spring 14 is connected firmly to carriage 12 at rear portion 13a of traction pin 13, so as to keep traction pin 13 substantially aligned with axis C as carriage 12 moves; and the two wings 14c and 14d of spring 14 are designed to remain substantially straight and parallel to axis C when carriage 12 is in the first position, and to flex gradually outwards, in opposite directions F perpendicular to axis A, i.e. towards lateral walls 7c of box body 7, into a fully flexed position (FIG. 6) when carriage 12 is moved into the second position, and into a partly flexed position (FIG. 5) when carriage 12 is moved into the third position.

The end of one of the wings, 14d, of spring 14 is connected to a first electric connector 18a of power means 18 by a strap of electrically conducting material; and central segment 14b of spring 14 is connected electrically to a second electric connector 18b of power means 18 by wire 16, and by an automatic switch 23, which opens automatically when electric current flow along wire 16 exceeds a predetermined maximum threshold, to prevent Joule-effect overheating and damage/failure of wire 16.

In the preferred embodiment in FIGS. 2-6, automatic switch 23 comprises a fixed electric contact 24 connected electrically to second electric connector 18b; and an oscillating arm 25 made of electrically conducting material, and which has a free end fitted with a movable electric contact 26 facing fixed electric contact 24, and an opposite end pivoting inside box body 7 to allow arm 25 to oscillate partly, about an axis G perpendicular to axes A and B, between a closed position (FIG. 3) in which movable electric contact 26 rests on fixed electric contact 24, and an open position (not shown) in which movable electric contact 26 is detached from fixed electric contact 24.

Automatic switch 23 also comprises an elastic member 27, e.g. a spring, interposed between arm 25 and an inner wall of box body 7 to hold arm 25 in the closed position; and a head 28 designed to connect the second end of wire 16 to arm 25, and which, alongside a variation in the length of wire 16, moves between a first and second position along axis C to swing arm 25 between the closed and open positions.

Elastic member 27 is designed so that head 28, activated by wire 16, moves arm 25 into the open position when current flow along wire 16 exceeds the predetermined maximum threshold.

In the preferred embodiment in FIG. 2, the first end of wire 16 is connected electrically to central segment 14b of spring 14, and the second end is connected to a preferably, though not necessarily, central portion of arm 25.

In the FIG. 2-6 example, wire 16 is made of nickel-titanium alloy, and is wound about head 28 and cylindrical portion 12a of carriage 12 to form a coil. More specifically, wire 16 is long enough to wind about carriage 12 and head 28 in a number of turns, which are kept taut between head 28 and carriage 12, and define five wire branches extending between carriage 12 and head 28 and substantially parallel to axis A.

In the FIG. 2-6 example, wire 16 has a total length, measured between the first and second end at ambient temperature, of roughly 387 mm, is roughly 0.2 mm in diameter, and is designed to vary in crystalline structure, and therefore length, when subjected to a predetermined transformation temperature, e.g. of roughly 100° C.

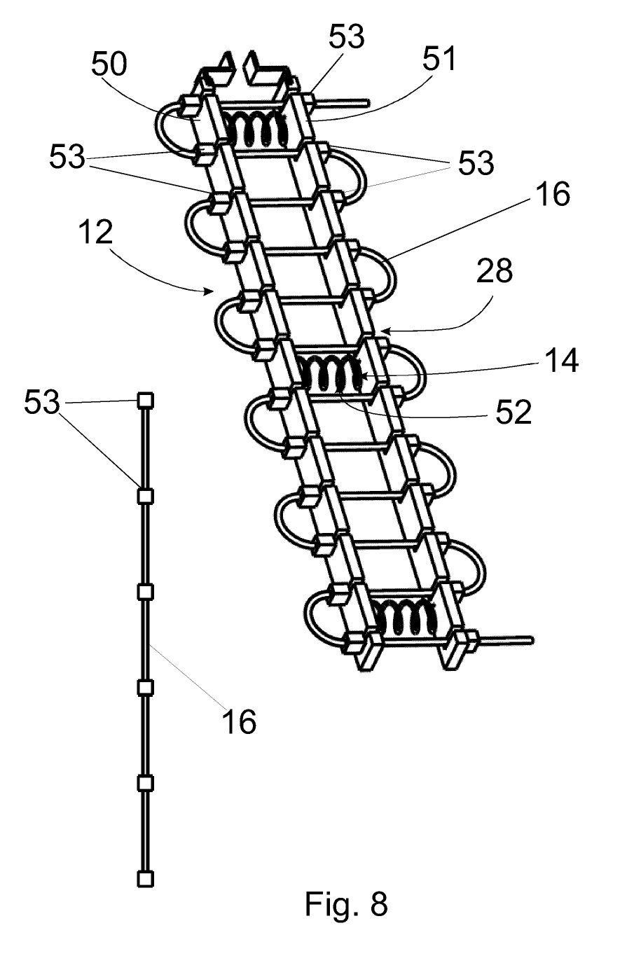

In a different embodiment shown in FIG. 8, carriage 12 and head 28 may either be connected or comprise two comb members 50, 51 mounted inside box body 7 to slide, parallel to axis C, between the positions described above; elastic thrust means 14 comprise one or more springs 52 interposed between comb members 51 and 52; and wire 16 advantageously comprises a crimped wire inserted inside the gaps between the teeth of comb members 50 and 51, with the crimped ends 53 resting on opposite outer faces of comb members 50 and 51. In the example shown, crimped ends 53 are equally spaced along wire 16, and, when the wire is inserted inside the gaps in comb members 50 and 51, keep comb members 50, 51 parallel to each other and a given distance apart.

Using a crimped wire 16 in comb members 50, 51 of carriage 12 and head 28 has the big advantage of enabling fast, low-cost assembly of the wire to head 28 and carriage 12, and ensuring correct spacing of head 28 and carriage 12 by means of the crimped ends, which act as locators when assembling the device.

Locking device 6 also comprises a safety switch 29 designed to cooperate with latch 8, catch 5a, and actuator 11 to cut off electric power supply to one or more electric/electronic devices of appliance 1, such as the electric motor powering the laundry drum, in the event of a predetermined hazard situation associated with failure to lock, or only partial locking of, door 5 in the closed position.

Safety switch 29 is connected by connectors 32 of locking device 6 to a power line powering electric/electronic devices (not shown) of appliance 1, e.g. the line powering the electric motor of the drum of appliance 1, and is designed to automatically switch to the open position to cut off the power line when latch 8 is in any other than the lock position, and to automatically switch to the closed position, not cutting off the power line, when latch 8 is in the fully locked position.

In the preferred embodiment in FIG. 2, safety switch 29 comprises a fixed electric contact 30 connected in a fixed position to box body 7; and a movable electric contact 31 fitted to box body 7 to move to and from fixed electric contact 30 to open/close safety switch 29.

More specifically, in the FIG. 2-6 example, fixed electric contact 30 is located on the free end of a fixed arm made of electrically conducting material, and which extends parallel to axis A, is positioned facing and alongside wing 14d, and is connected at the opposite end to a first electric connector 32. And movable electric contact 31 is located on an intermediate portion of a movable arm made of electrically conducting material, and which extends parallel to axis A, is located between the fixed arm and a lateral wall 7c, on the opposite side to wing 14d, and is connected electrically to a second electric connector 32.

The movable arm fitted with movable electric contact 31 is designed to move movable electric contact 31 to and from fixed electric contact 30 in a direction substantially perpendicular to axis A.

Safety switch 29 also comprises a safety pin 34 fitted to latch 8, and which, as latch 8 rotates, moves axially in direction D along an axis H parallel to axis A, and in opposition to elastic devices, e.g. a spring (not shown) fitted to safety pin 34, between latch 8 and partition 17; and a lever mechanism 35 interposed between safety pin 34 and movable electric contact 31, and designed to move movable electric contact 31 between the closed position and the open position as safety pin 34 moves axially.

In the preferred embodiment shown in FIG. 2, lever mechanism 35 comprises a substantially inverted-L-shaped arm, the short leg of which has a first end 35a resting on movable electric contact 31, and the long leg of which has a second end fixed firmly to safety pin 34, and a curved central portion resting in sliding manner on a guide or supporting portion 36 fixed firmly to box body 7.

The guide or supporting portion 36 is located at partition 17, between lever mechanism 35 and carriage 12, and is shaped to form a surface sloping with respect to axis A, i.e. a cam, and on which the central portion of lever mechanism 35 slides as the lever mechanism withdraws inside box body 7.

More specifically, the sloping surface of supporting portion 36 is designed to slide lever mechanism 35 between a minimum withdrawal position, in which first end 35a keeps movable electric contact 31 at a maximum distance from fixed electric contact 30, and a maximum withdrawal position, in which the bend connecting the long and short legs of lever mechanism 35 is positioned close to wing 14d, and first end 35a holds movable electric contact 31 resting on fixed electric contact 30.

As wing 14d inside box body 7 flexes in direction F, it also moves lever mechanism 35 from the maximum withdrawal position closing safety switch 29, to a safety position, in which first end 35a of lever mechanism 35 pushes movable electric contact 31 in direction F, thus detaching it from fixed electric contact 30 and opening safety switch 29.

In a preferred embodiment shown in FIGS. 2-6, safety pin 34 is located alongside traction pin 13 and fitted in axially sliding manner through a hole in partition 17 and a hole in latch 8. The rear end of safety pin 34 is connected to lever mechanism 35, and the opposite end has a head 34a, which projects inside a lock groove 8a formed in latch 8 and designed to receive a projecting portion of catch 5a on door 5.

More specifically, the projecting portion of catch 5a on door 5, and the lock groove 8a in the latch are complementary in shape, so that the projecting portion, as it engages lock groove 8a, pushes safety pin 34 axially in direction D.

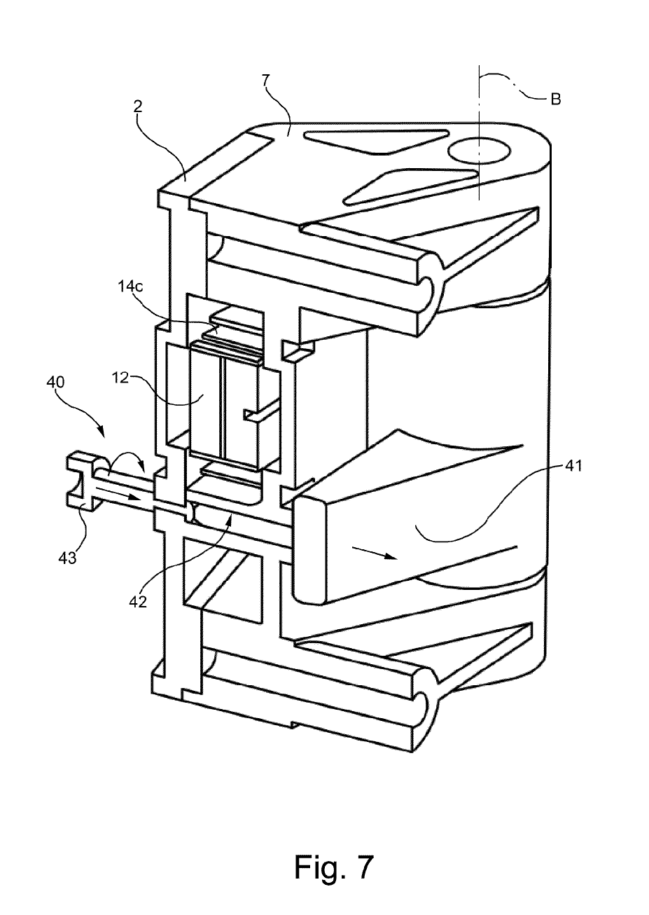

In the FIG. 7 embodiment, locking device 6 also comprises a mechanical manual release mechanism 40, by which to release door 5 manually in the event of power failure to locking device 6 and/or a malfunction of actuator 11 caused, for example, by wire 16 breaking.

More specifically, mechanical manual release mechanism 40 comprises a lever 41 connected firmly to latch 8 to rotate about axis B and rotate latch 8 from the lock position to the release position; a through opening 42 extending, perpendicularly to axis B, through casing 2 and box body 7, and having a first end in view and accessible from outside appliance 1, and a second end facing lever 41; and a manual release tool 43, which can be inserted inside opening 42 and operated manually to exert force on lever 41 to rotate latch 8 from the closed to the open position.

In a preferred embodiment shown in FIG. 7, manual release tool 43 comprises a threaded rod, which screws manually inside a preferably small-pitch nut screw inside the opening, so as to move longitudinally to and from lever 41 and so rotate latch 8 from the closed to the open position.

Operation of locking device 6 will now be described with reference to FIGS. 3, 4, 5 and 6, and as of the condition in which door 5 is open and latch 8 is free, i.e. is completely detached from catch 5a on the catch arm on door 5 (FIG. 3).

At this stage, traction pin 13 is fully extracted, because of the thrust exerted by elastic thrust means 14 on carriage 12, so latch 8 is pushed by the elastic members into the rest position.

In the FIG. 3 condition, carriage 12 is in the first position; wings 14c and 14d of elastic thrust means 14 are substantially parallel to each other and to axis A; head 28 is held in the first position by oscillating arm 25, thus closing automatic switch 23; and safety pin 34 is fully extracted by the elastic devices, and holds lever mechanism 35 in the minimum withdrawal position in which first end 35a keeps movable electric contact 31 at the maximum distance from fixed electric contact 30, thus opening safety switch 29.

With reference to FIGS. 4 and 5, when door 5 is pushed into the closed position, the lock surface of catch 5a slides on the lock surface of latch 8, so that latch 8 first rotates towards partition 17 from the rest position to the release position (FIG. 4), and then rotates in the opposite direction to fully engage catch 5a on door 5, with the projecting portion (not shown) of catch 5a seated completely inside groove 8a in latch 8 (FIG. 5).

With reference to FIG. 4, during the first rotation of latch 8, safety pin 34 withdraws axially, pushed partly by catch 5a, and slides lever mechanism 35 in direction D along supporting portion 36. At the same time, traction pin 13 moves from the first to the second position in opposition to the elastic force exerted by wings 14c and 14d, which flex gradually outwards into the fully flexed position, in which one of them intercepts and moves lever mechanism 35 in direction F into the safety position holding safety switch 29 in the open position.

With reference to FIG. 5, door 5 is fully closed when the projecting portion of catch 5a engages the lock groove 8a in latch 8. At this stage, latch 8 is held onto catch 5a by the thrust members; elastic thrust means 14 push carriage 12 axially in direction E into the third position to insert the front portion of safety pin 34 into slot 5c in catch 5a; wings 14c and 14d move from the fully flexed to the partly flexed position; and the projecting portion of catch 5a pushes safety pin 34 axially along supporting portion 36 of the box body into the maximum withdrawal position, in which first end 35a of lever mechanism 35 brings movable contact 31 into contact with fixed contact 30 to close safety switch 29 and so power the motor.

With reference to FIG. 6, door 5 can be moved from the closed to the open position when electronic control means (not shown) controlling electric power means 18 supply electric connectors 18a, 18b with a predetermined electric current, which produces a controlled Joule-effect variation in the temperature of wire 16 to shorten the wire. As the wire shortens, carriage 12 moves from the third to the second position, and traction pin 13 withdraws axially in direction D to rotate latch 8 from the lock position to the release position (FIG. 6). As carriage 12 withdraws, wings 14c and 14d flex outwards into the fully flexed position, in which one of them (wing 14d in FIG. 6) pushes lever mechanism 35 in direction F into the safety position opening safety switch 29.

At this point, traction pin 13 is held in the withdrawn position by carriage 12 and is therefore fully detached from slot 5c in catch 5a, which can therefore be withdrawn from latch 8 by exerting thrust on door 5 away from casing 2.

Accordingly, door 5 may be fitted with an elastic seal designed to push it away from casing 2, or elastic means may be interposed between casing 2 and door 5 to move door 5 automatically into the open position when locking device 6 is released.

Once door 5 is opened, the electronic control means (not shown) can cut off current supply to connectors 18a, 18b to gradually cool wire 16. As it cools, wire 16 increases in length and, at the same time, elastic thrust means 14 restore carriage 12 to the first position, thus extracting traction pin 13 and allowing the elastic members to restore latch 8 to the rest position (FIG. 3).

In the release position (FIG. 4), latch 8 is secured by traction pin 13 to carriage 12, and rests against partition 17 to prevent any further withdrawal of carriage 12 in direction D. Any increase, over and above the predetermined threshold, in current flow through wire 16 therefore produces a further reduction in the length of wire 16, which moves head 28 in direction E, in opposition to the force exerted by elastic member 27 on oscillating arm 25, so oscillating arm 25 rotates into the open position opening automatic switch 23.

In connection with the above, it should be pointed out that, in a different embodiment, locking device 6 may also be used to advantage in technical applications other than electric household appliances as described above. For example, it may be used to lock a drawer or door in a closed position closing a compartment formed in furniture, or in vehicles, such as motor vehicles, aircraft, trains, ships, or similar.

The locking device described has the advantage of being electrically and mechanically simpler, and therefore faster and cheaper to produce.

In addition, besides being easy to produce, the safety switch of the locking device is designed to only supply power, e.g. to the electric motor, when the door is fully closed, thus making the appliance safer.

The locking device is also efficient in terms of energy saving, by featuring no electronic, positive-temperature-coefficient components.

Clearly, changes may be made to the locking device as described and illustrated herein without, however, departing from the protective scope of the present invention as defined in the accompanying Claims.

1. An electric household appliance comprising: a casing; a compartment housed inside the casing and facing an opening formed in the casing; a door fitted to the casing and movable between an open position and a closed position opening and closing the opening respectively; and a locking device for locking the door in the closed position to the casing;
said locking device comprising:
a box body fixed to the casing, alongside the door;
latch means fitted to the box body to move between at least a lock position locking the door, and a release position releasing the door; and
actuating means for selectively moving said latch means between said lock position and said release position;
said actuating means comprising:
a shape-memory thrust-bearing device comprising at least an electrically conducting resistance wire made of a shape-memory alloy and designed to vary in length alongside a variation in temperature; and
electric power means for powering said resistance wire and producing a controlled Joule-effect variation in temperature.

2. An electric household appliance as claimed in claim 1, wherein said locking device comprises a safety switch, for opening/closing a power circuit powering electric/electronic means on the appliance, and which cooperates with said actuating means and/or said latch means so as to be switched to open or closed by predetermined movements of the latch means and/or said actuating means in said box body.

3. An electric household appliance as claimed in claim 1, and comprising an automatic switch interposed electrically between said electric power means and said resistance wire, and which switches between a closed position and an open position on the basis of current flow through said resistance wire; said automatic switch cooperating with said resistance wire so as to be switched to the open position by a reduction in length of said resistance wire over and above a minimum length threshold associated with a predetermined maximum current threshold.

4. An electric household appliance as claimed in claim 1, wherein said latch means comprise:
a latch hinged to the box body to at least rotate, about a first axis, between said lock position locking said door, and in which the latch engages a catch on said door to hold the door in the closed position; and said release position releasing said door, and in which the latch is detached from the catch on the door to allow the door to move into the open position; and
a traction pin, which is movable axially, along a second axis perpendicular to said first axis, in a reverse direction or a forward direction opposite the reverse direction, and is connected to the latch so that axial movement of the traction pin in the reverse direction rotates the latch into the release position; the traction pin being connected to said resistance wire, so that a reduction in the length of the resistance wire moves the traction pin axially in the reverse direction.

5. An electric household appliance as claimed in claim 4, wherein said actuating means comprise:
a carriage fitted inside the box body to move axially along said second axis, and connected to the traction pin and the shape-memory thrust-bearing device so that a reduction in the length of the resistance wire moves the traction pin axially in the reverse direction; and
elastic thrust means connected to the carriage to move it in the forward direction when the resistance wire increases in length.

6. An electric household appliance as claimed in claim 5, wherein said elastic thrust means comprise a U-shaped spring having two ends fixed rigidly to the box body, and a central segment fitted firmly to said carriage so as to exert elastic thrust on the carriage in the forward direction.

7. An electric household appliance as claimed in claim 6, wherein said elastic thrust means comprise two flexible wings designed to: remain substantially straight and parallel to the second axis when the carriage is in a first position associated with a rest position of the latch; flex gradually outwards, in opposite directions perpendicular to the second axis and parallel to the first axis, into a fully flexed position when the carriage is reversed into a second position associated with said release position of the latch; and flex into a partly flexed position when the carriage is moved from the second to a third position between the first and second position.

8. An electric household appliance as claimed in claim 7, wherein one (14d) of the wings, at least one resistance wire (16), and said automatic switch are series-connected between a first and second electric connector of said electric power means (18).

9. An electric household appliance as claimed in claim 8, wherein said automatic switch comprises a fixed electric contact; an arm having a movable electric contact and connected to the box body to oscillate between a closed position connecting the movable contact to the fixed contact, and an open position disconnecting the movable contact; a head connecting one end of said at least one resistance wire to the arm, and which is movable along the second axis; and elastic means, which cooperate with the arm to allow the arm to be moved, by the head activated by the resistance wire, into the open position when current flow in the resistance wire exceeds said predetermined maximum current threshold.

10. An electric household appliance as claimed in claim 9, wherein said safety switch comprises a fixed electric contact; a movable electric contact movable between a closed position connected to the fixed contact, and an open position disconnected from the fixed contact; a safety pin connected mechanically to the latch and movable axially along a third axis parallel to the second axis; a lever mechanism interposed between the safety pin and the movable electric contact, and designed to move the movable electric contact between the closed position connected to the fixed contact (30), and the open position disconnected from the fixed contact, as the safety pin is moved axially by movement of the latch into the rest position or release position.

11. An electric household appliance as claimed in claim 10, wherein the lever mechanism comprises a first end resting on the movable electric contact; a second end fixed firmly to the safety pin; and a curved central portion resting slidably on a supporting portion, which is fixed firmly to the box body and shaped to form a sloping surface with respect to the longitudinal axis, and on which the central portion of the lever mechanism slides as the safety pin moves axially.

12. An electric household appliance as claimed in claim 11, wherein said lever mechanism slides on said supporting portion between a minimum withdrawal position, in which said first end holds the movable electric contact at a maximum distance from the fixed electric contact, and a maximum withdrawal position, in which the curved central portion of the lever mechanism is positioned close to one wing, and the first end of the lever mechanism holds the movable electric contact resting on the fixed electric contact.

13. An electric household appliance as claimed in claim 11, wherein said lever mechanism is moved, by one wing flexing into the fully flexed position inside the box body, from the maximum withdrawal position associated with closing the automatic switch, to a safety position, in which the first end of the lever mechanism detaches the movable electric contact from the fixed electric contact to open the automatic switch.

14. An electric household appliance as claimed in claim 13, wherein said safety pin is connected at its rear end to the lever mechanism, and, at the opposite end, has a head which projects inside a lock groove formed in the latch and designed to receive a projecting portion of the catch on the door; the safety pin being pushed axially by the projecting portion of the catch on the door, as the projecting portion of the catch engages the lock groove.

15. An electric household appliance as claimed in claim 2, and comprising a mechanical manual release mechanism, in turn comprising a lever connected firmly to the latch and which is rotated about the first axis to rotate the latch between the lock position and the release position; and a user-operated manual release tool, by which to rotate the lever to rotate the latch from the lock position to the release position.
